(19) United States
(12) Patent Application Publication
(10) Pub. No.: US 2012/0049539 A1
(43) Pub. Date: Mar. 1, 2012

(54) CART

(75) Inventor: Thomas Sanvik, Norrkoping (SE)

(73) Assignee: OSTERGOTLANDS FASTIGHETSSERVICE SAMT EL OCH LARM I NORRKOPING AB, Norrkoping (SE)

(21) Appl. No.: 13/264,555

(22) PCT Filed: Apr. 15, 2010
(86) PCT No.: PCT/SE2010/000096

§ 371 Date: Oct. 26, 2011

(30) Foreign Application Priority Data
Apr. 20, 2009 (SE) 0900524-0

(51) Int. Cl. H02K 47/00

(52) U.S. Cl. 290/1 R

(57) ABSTRACT

A cart includes a rotor (9, 7) which cooperates with a stator (7, 9) arranged in the ground, such that they conjointly constitute a dynamoelectric machine. The rotor (9, 7) has an essentially flat lower surface arranged on the cart near the ground surface. The cart includes a control device (5) that controls the dynamoelectric machine and it may include an accumulator (6). The dynamoelectric machine is controllable such that is generates electric power, which may be used for powering electronic equipment in the cart. Such a cart where the dynamoelectric machine is controllable such that it counteracts movements between the rotor and the stator is also described. The cart may thus be locked in place without need for any further locking device. The magnetic locking function may also be activated to prevent thefts.

The present invention relates to a cart according to the introductory portions of the independent claim.

### BACKGROUND OF THE INVENTION

Shopping carts are often available for use in a supermarket or in the vicinity of a supermarket. To increase the customers' disposition to return the shopping carts to the storage area after use, they are often locked in place with a lock that may be opened with a token or coin that is recovered when the shopping cart again locked in place at the storage area. It may also be necessary to provide carts with some kind of controllable wheel brake or lock that may be activated in case the cart is stolen.

Many supermarkets use digital equipment where the customer himself registers goods that are put inside the cart. The digital equipment consumes power and is provided with batteries that have to be exchanged or recharged.

An object of the invention is therefore to provide a cart which both is able to provide power for electrical equipment without an external supply and is able to lock the cart in place.

These and other objects are attained by a cart according to the characterising portion of the independent claims.

### SUMMARY OF THE INVENTION

The invention relates to a cart comprising a rotor 9, 7 arranged to cooperate with a stator 7, 9 arranged in the ground, such that they conjointly constitute a dynamoelectric machine. The rotor 9, 7 has an essentially flat lower surface arranged on the cart near the ground surface. The cart comprises a control device 5 that controls at least the dynamoelectric machine and it may advantageously comprise an accumulator 6. The dynamoelectric machine is controllable such that is at least generates electric power, which advantageously may be used for powering electronic equipment in the cart.

The invention further relates to such a cart where the dynamoelectric machine is controllable such that it counteracts movements between the rotor and the stator. This has the advantageous result that the cart may be locked in place without need for any further, typically mechanical, locking device. Such separate locking devices are typically used in the sheds where shopping carts are stored when not used, and these may be unlocked with a coin. The magnetic locking function may advantageously be controlled to work in a corresponding way without an additional mechanical lock. The magnetic locking function may also be activated to prevent thefts.

### BRIEF DESCRIPTION OF THE DRAWINGS

FIG. 1 shows a first embodiment of the cart according to the invention

FIG. 2 shows a second embodiment of the cart according to the invention

FIG. 3 shows magnetic tracks for a cart according to the invention

### DESCRIPTION OF PREFERRED EMBODIMENTS

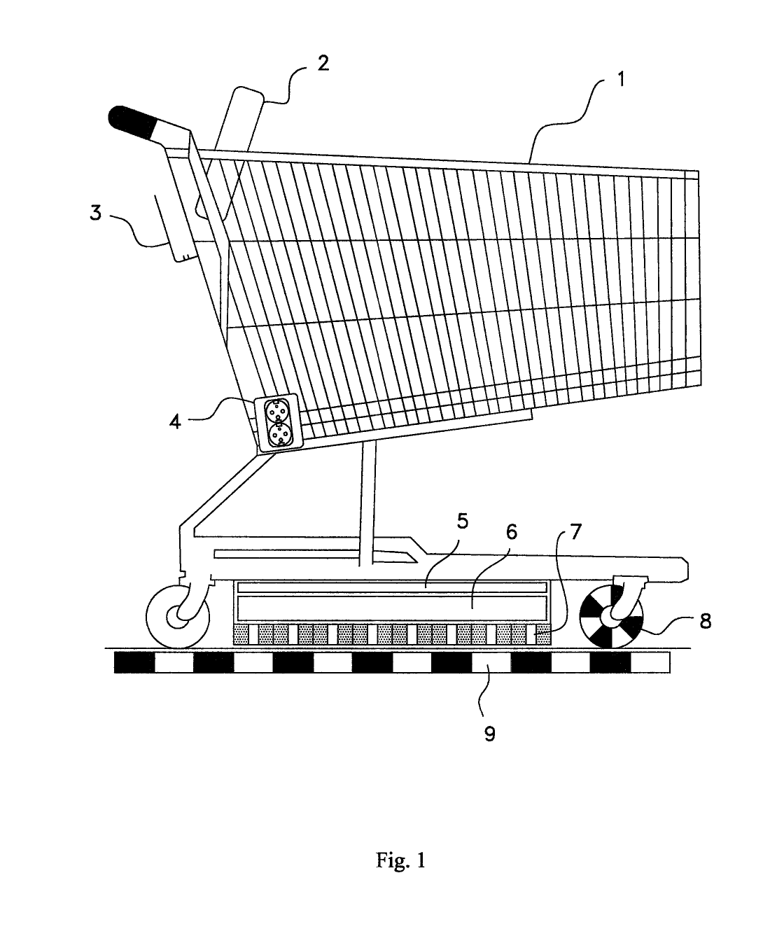

FIG. 1 shows a first embodiment of the cart according to the invention, illustrated here as a shopping cart 1. On the underside of the shopping cart a set of coils 7 are arranged that runs immediately above the floor surface over which the cart is pushed. Immediately below the floor surface a series of magnets 9 are arranged with their magnetic field directed upwards or downwards. Every second magnet in the series has its magnetic filed directed upwards and every second has its magnetic field directed downwards, such that when the cart is moved, an AC voltage is generated in every coil.

The induced AC voltage may generate a current that may be used for charging an accumulator 6 that is arranged below the cart and is situated above the coils. The voltage generated by the coils is controlled in a suitable fashion by an electronic control device 5. The control device may draw a chosen current from the coils and use this for charging the accumulator and/or for powering the other electronic devices on the cart. If the coils don't generate a voltage, the control device may draw current from the accumulator to power the other electronic devices. In order to facilitate pushing the cart forward, the control device may electrically disconnect the coils such that resistance to propulsion is minimized.

If the control device receives information that the cart has left the allowed area or if an alarm indicating that the cart or the contents of the cart is stolen, the control device may conversely pull current from the accumulator to the coils, such that these generate a magnetic field that locks the cart to the magnets 9 in the floor. To make this possible at all circumstances, the accumulator must always be charged to a certain least degree and the control device may therefore be designed to always charge the accumulator when the coils are generating a voltage, at least until this minimum charging level is achieved.

The cart is further provided with a display 2. The display may be used for presenting advertising information to the customer and it may be provided with an input device for keeping track of goods put in the cart and the cost of these. The display may also be used by support staff for reading information regarding the properties of the electromagnetic part or in order to control that. If a sizeable quantity of power is accumulated, this may be discharged via a charging outlet 4, and the customer thus generates electrical power when the cart is pushed that may be used locally in the store or even being supplied to the power grid. Depending on how the electronics is designed, it may need a certain minimum quantity of electrical power for starting up and this may then be supplied to the system through the charging outlet 4.

The cart it further provided with a charger 3 for mobile phones or similar. The charging current is intended to be generated by the customer himself and the control device 5 might control the amount of current being pulled from the coils depending on the customers' use of current from the charger 3. If the customer chooses to charge a mobile phone, the cart will be somewhat harder to push and if the customer doesn't use this function, the cart runs somewhat easier.

The front wheels 8 of the cart in themselves constitute yet a generator, where the wheel is a rotor comprising permanent magnets and a stator part is arranged at the wheel attachment which may provide additional electrical power to the control device 5. The control device also controls the front wheel generator and the withdrawn current may be controlled such that a varying degree of force is necessary in order to push the cart forward. By maximizing withdrawn electrical power, the force necessary to rotate the wheel and thus push the cart forward is elevated. This may be used for preventing thefts and is useable even when the cart is outside the area where magnets 9 are provided in the floor. By instead supplying DC current to the stator in the front wheel, the wheel may be locked in place even more forcefully. As the coils 7 are situated near the magnets 9 in the floor over a large are, the cart may be locked in place with a considerably larger force than by activating the magnetic fields generated by the coils.

The display 2 may be provided with a coin slot and may be programmed to lock the cart in place using the coils if the correct amount has not been deposited for borrowing the cart. Through the coils, the cart is provided with what may practically be considered a sensor system that is able to sense if the cart is moved as a voltage is generated by the coils as the cart is moved. If this takes place and the correct amount has not be deposited, the coils may be activated locking the cart in place, which means the coils don not have to be activated continuously in order to lock the cart in place. In this way, mechanical locking devices may be eliminated that are often used to prevent customers from borrowing a cart without depositing a coin. Information regarding whether the cart should be locked in place due to it being stolen or for other reasons may be transmitted using RF sent to a receiver in the display or directly built into the control device 5.

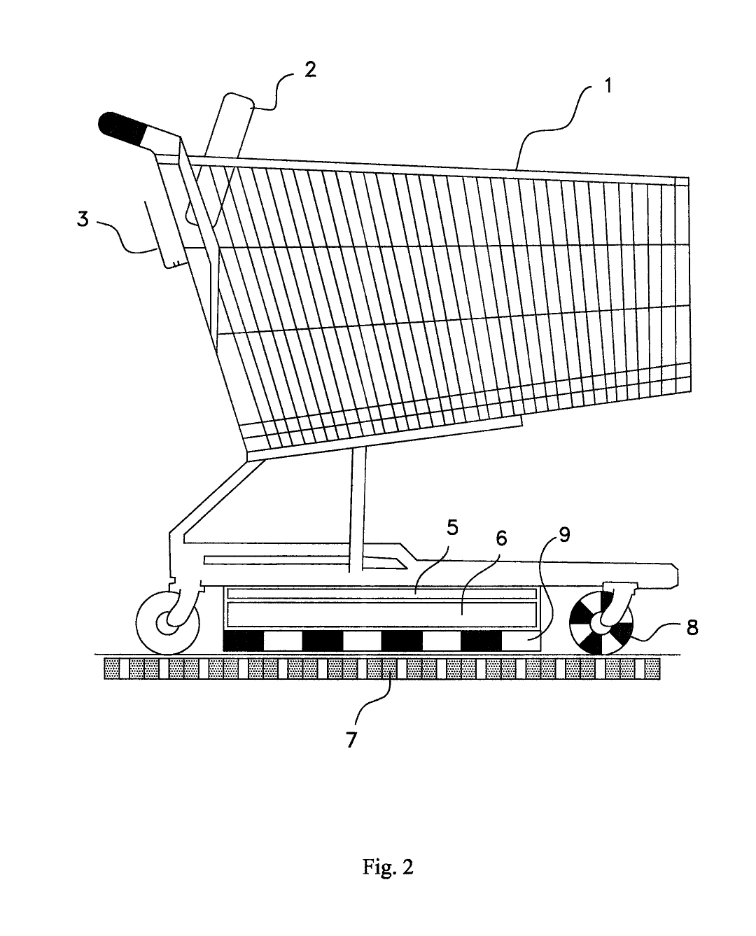

FIG. 2 shows a second embodiment of the cart according to the invention, which primarily differs from the first embodiment in that a series of magnets 9 are arranged on the underside of the cart and in that a set of coils 7 are arranged immediately under the floor surface, that is the opposite of the first embodiment. In the same way as in the first embodiment, an AC voltage is generated in the coils as the permanent magnets move over the floor surface as the cart is pushed. The generated voltage may be used for drawing a current that is transferred via conductors in the floor for local use or, after appropriate voltage and frequency transformation, may be supplied to the power grid.

In the same way as in the first embodiment, selected coils in the floor may be powered to generate a magnetic field and thus lock a selected cart in place.

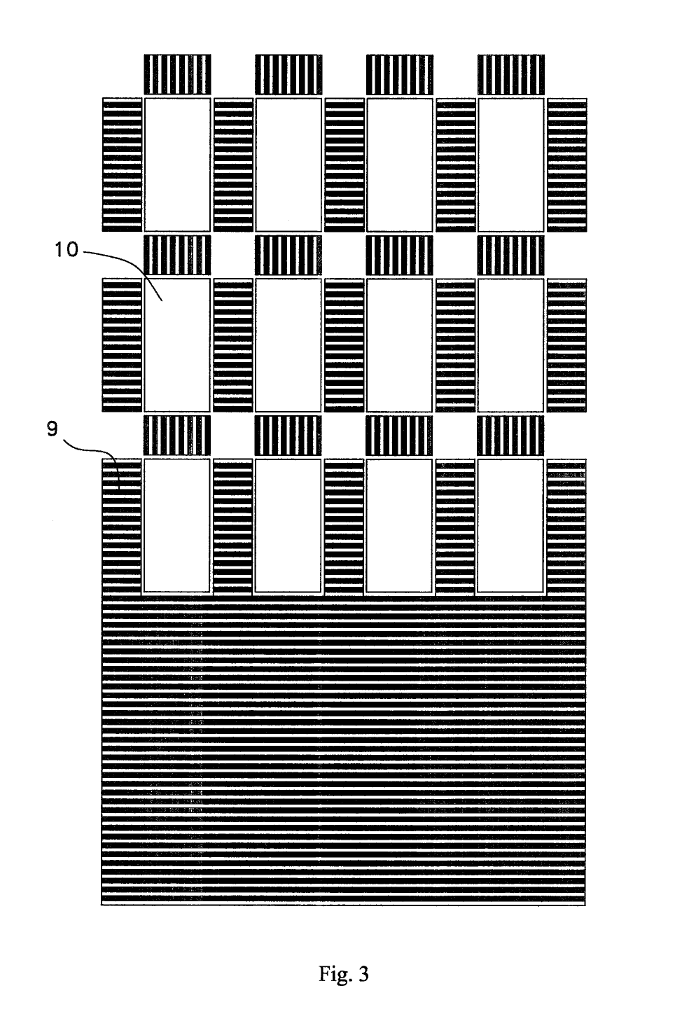

FIG. 3 shows magnetic tracks 9 for a cart in a supermarket. The tracks are constituted by rows of magnets with the magnetic filed of every second magnet being directed upward from the floor and every second magnet having its magnetic field directed downwards. The series of magnets are arranged in the direction of motion of carts in aisles between the display cases 10 and in the intersections between aisles extending perpendicularly to each other magnets are lacking as the carts here may move in different directions. The generation of electrical power is equally efficient whether the cart is moving forward or backwards in the direction the series, but no power is generated during movement perpendicularly to the direction of extension of the series. Neither does the locking function work if the cart is set perpendicularly to the direction of extension of the series, so the series of magnets are arranged such that they are useable at the exit from the supermarket, shown at the lower part of the figure, where carts are directed towards or away from the exit. The series of magnets are correspondingly arranged in the sheds where shopping carts are stored when not used, such that they may be activated.

The invention include both illustrated embodiments and the cooperating coils 7 and magnets 9 do conjointly form a dynamoelectric device that may act as either a generator or, when the locking function is used, as a motor. These two parts are defined in the claims as a stator and a rotor, even though the concept of a rotor normally is used for rotating parts.

1. A cart comprising a rotor (9, 7) arranged to cooperate with a stator (7, 9) arranged in the ground, such that they conjointly constitute a dynamoelectric machine, characterised in that said rotor (9, 7) is provided with an essentially flat lower surface arranged on the cart near the ground surface.

2. A cart according to claim 1, characterised in that it comprises an accumulator (6).

3. A cart according to claim 1, characterised in that it comprises an outlet (3, 4) for drawing electrical power from the dynamoelectric machine and/or the accumulator (6).

4. A cart according to claim 2, characterised in that it comprises an outlet (3, 4) for drawing electrical power from the dynamoelectric machine and/or the accumulator (6).
